(19) United States
(12) Patent Application Publication
(10) Pub. No.: US 2026/0192674 A1
(43) Pub. Date: Jul. 9, 2026

(54) ABSTRACT SOFTWARE INTERFACES IN BATTERY MANAGEMENT SYSTEMS

(71) Applicant: VISTEON GLOBAL TECHNOLOGIES, INC., Van Buren Township, MI (US)

(72) Inventors: Fiona E. Meyer-Teruel, Detroit, MI (US); Vivekananda Shripathy, South Lyon, MI (US); Pavlin Stefanov Nedelchev, Sofia (BG)

(73) Assignee: VISTEON GLOBAL TECHNOLOGIES, INC., Van Buren Township, MI (US)

(21) Appl. No.: 19/435,849

(22) Filed: Dec. 30, 2025

Related U.S. Application Data
(60) Provisional application No. 63/741,518, filed on Jan. 3, 2025.

(51) Int. Cl. B60L 3/00; B60L 58/12; B60L 58/16; H01M 10/42

(52) U.S. Cl. CPC B60L 3/0046; B60L 58/12; B60L 58/16; H01M 10/425; B60L 2240/545; B60L 2240/547; B60L 2250/00; H01M 2010/4271; H01M 2220/20

(57) ABSTRACT

A method for abstracting a plurality of software interfaces in a battery management system includes monitoring a rechargeable energy storage system of a vehicle with multiple battery monitoring sensors, receiving data from the battery monitoring sensors in multiple non-standard formats at an agnostic interface layer of an agnostic battery monitoring integrated circuit controller, converting the data received at the agnostic interface layer via an abstraction layer into a unified format, decoupling multiple communication protocols of multiple battery monitoring interface circuits in the agnostic battery monitoring integrated circuit controller to interact with a specific battery monitoring interface controller, where the data includes a multiple cell voltages, multiple battery module temperatures, and multiple battery cell sensing diagnostics in the rechargeable energy storage system, and transmitting one or more messages to a driver of the vehicle based on the cell voltages, the battery module temperatures, and the battery cell sensing diagnostics.

### CROSS-REFERENCE TO RELATED APPLICATIONS

This application claims the benefit of U.S. Provisional Application Number 63/741,518, filed January 3, 2025, which is hereby incorporated by reference in its entirety.

### TECHNICAL FIELD

The present disclosure generally relates to systems and methods for abstracting software interfaces in battery management systems.

### BACKGROUND

Software for specific battery monitoring integrated circuits or sensors within a battery management system is currently dependent on a hardware architecture and software infrastructure of the systems. Traditionally, communication between battery monitoring sensors and the battery management controller relies on proprietary hardware interfaces resulting in dedicated communication peripherals and custom software drivers. The dependencies limit the flexibility of the system by enforcing selections of specific battery monitoring integrated circuits that are compatible with the hardware and the software infrastructure.

Accordingly, those skilled in the art continue with research and development efforts in the field of abstract software interfaces in battery management systems.

### SUMMARY

A method for abstracting a plurality of software interfaces in a battery management system is provided herein. The method includes monitoring a rechargeable energy storage system of a vehicle with a plurality of battery monitoring sensors, receiving data from the plurality of battery monitoring sensors in a plurality of non-standard formats at an agnostic interface layer of an agnostic battery monitoring integrated circuit controller, converting the data received at the agnostic interface layer via an abstraction layer into a unified format, decoupling a plurality of communication protocols of the plurality of battery monitoring interface circuits in the agnostic battery monitoring integrated circuit controller, where the data includes a plurality of cell voltages, a plurality of battery module temperatures, and a plurality of battery cell sensing diagnostics in the rechargeable energy storage system, and transmitting one or more messages to a driver of the vehicle based on the plurality of cell voltages, the plurality of battery module temperatures, and the plurality of battery cell sensing diagnostics.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a schematic diagram of a context in accordance with one or more exemplary embodiments.

FIG. 2 illustrates a schematic diagram of an architecture of a battery management system in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a method for abstracting software interfaces between battery monitoring sensors and a battery management controller within a battery management system (BMS). The method enables final system integrators (customers) to integrate a diverse range of battery monitoring sensors, independent of specific sensor models or manufacturers, into various battery management systems. An agnostic interface mechanism promotes compatibility, enhances system design adaptability, and optimizes an overall functionality of the battery management systems.

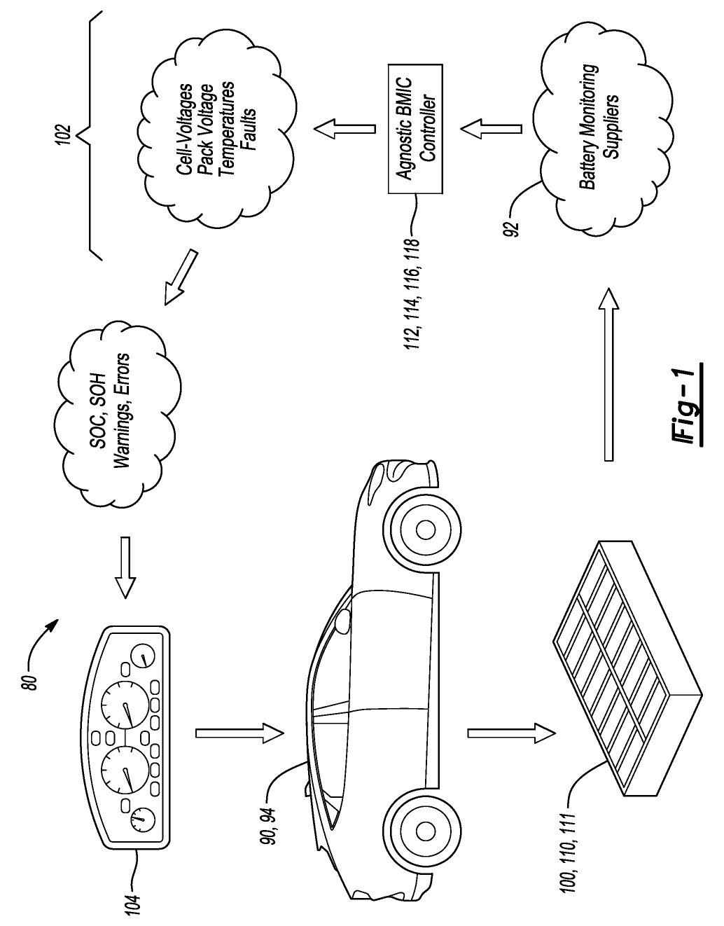

FIG. 1 illustrates a schematic diagram of an example context 80 in accordance with one or more exemplary embodiments. The context 80 includes an electric vehicle 90 and battery monitoring suppliers 92. The electric vehicle 90 generally includes a rechargeable energy storage system (RESS) 100, a battery management system (BMS) 102, and a console display 104. The RESS 100 may include multiple battery modules each having multiple battery cells, multiple battery monitoring sensors 110, and a battery monitoring integrated circuit 111. The battery management system 102 generally includes battery monitoring supplier software 112, an agnostic battery monitoring integrated circuit (BMIC) controller 114, battery performance software 116, and fault detection software 118.

In various embodiments of the disclosure, the agnostic BMIC controller 114 decouples communication protocols from the underlying battery monitoring sensors 110 and the battery monitoring integrated circuit 111. Regardless of the specific battery monitoring integrated circuit 111 used to monitor battery modules within the RESS 100, the agnostic BMIC controller 114 receives the data, such as cell voltages, battery module temperatures, battery cell sensing diagnostics, and other parameters, through the battery monitoring supplier software 112 provided by the battery monitoring suppliers 92 and converts the data into a unified (standardized) format.

The standardized data may subsequently be used by the battery performance software 116 in the battery management system 102 to calculate a state of charge (SoC), a state of health (SoH), and other metrics. Additionally, the fault detection software 118 in the battery management system 102 may be operational to detect problems within the RESS 100, issue warnings, and/or trigger errors for a driver 94 of the vehicle 90 via the console display 104. The detection mechanisms may be both measured via hardware-based solutions, such as through the agnostic BMIC controller 114, and software-based solutions, such as by comparing measurements between different battery cells and battery modules in the RESS 100 to determine differences.

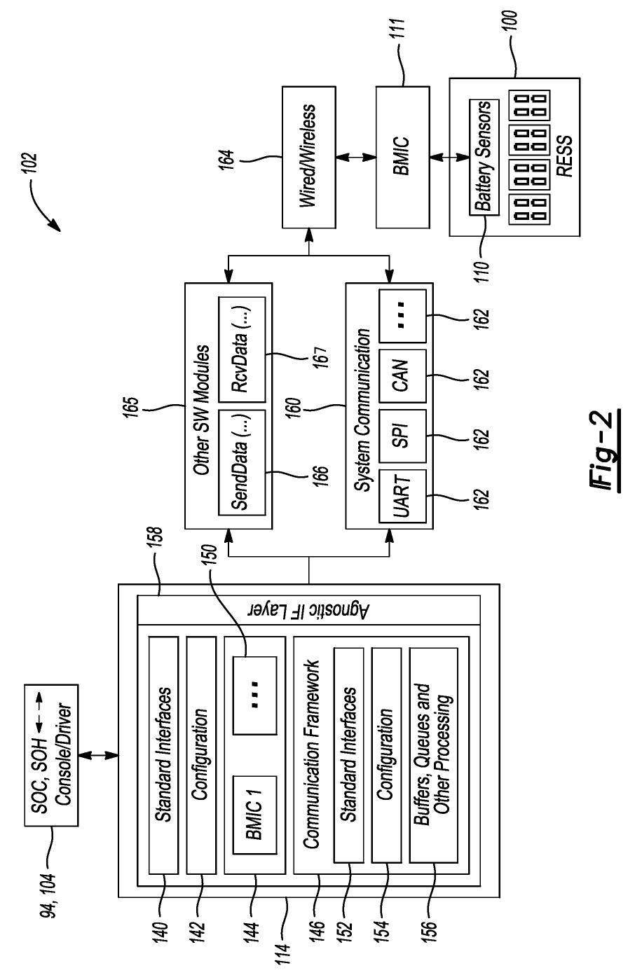

FIG. 2 illustrates a schematic diagram of an example implementation of an architecture of the battery management system 102 in accordance with one or more exemplary embodiments. Components within the agnostic BMIC controller 114 generally includes a controller standard input/output interface application programming interfaces (standard APIs) 140, a configuration layer 142, an abstraction layer 144, a communication framework 146, and an agnostic interface layer 148. The abstraction layer 144 includes multiple BMIC X libraries 150. The communication framework 146 includes multiple standard interfaces 152, confirmation information 154, and buffers, queues and other processing resources 156.

The agnostic BMIC controller 114 is generally operational to monitor the rechargeable energy storage system 100 of the vehicle 90 through the battery monitoring sensors 110. The agnostic BMIC controller 114 receives data from the battery monitoring sensors 110 via the battery monitoring integrated circuit 111 in multiple non-standard formats at the agnostic interface layer 148. The received data is converted via the abstraction layer144 into a unified format. The agnostic BMIC controller 114 subsequently decouples multiple communication protocols of multiple battery monitoring interface circuits 111 to interact with a specific battery monitoring interface circuit 111 among many possible battery monitoring interface circuits that may be installed in the vehicle 90. The data may include, but is not limited to, multiple cell voltages, multiple battery module temperatures, and a multiple battery cell sensing diagnostics in the rechargeable energy storage system 100. The agnostic BMIC controller 114 may transmit one or more messages to the driver 94 and/or the specific BMIC 111 based on the cell voltages, the battery module temperatures, and the battery cell sensing diagnostics.

The agnostic BMIC controller 114 may also select a specific BMIC X library 150 among the several BMIC X libraries 150 to interact with the specific battery monitoring interface circuit 111. Each BMIC X library 150 contains pre-defined communication information to interact with the corresponding battery monitoring interface circuits 111. When a specific (e.g., current) BMIC 111 in the vehicle 90 is replaced with a different BMIC 111, the agnostic BMIC controller 114 may select a different BMIC X library 150 that is tailored to interact with the different (e.g., newly installed BMIC 111. In some situations, a particular BMIC X library 150 may be modified per updates from the suppliers 92 (FIG. 1). Modifying a particular library 150 may be achieved without altering the other libraries 150.

The agnostic BMIC controller 114 generally receives action requests (or commands) via a controller standard I/O APIs 140. The requests are translated into a single command or a sequence of commands for the battery monitoring integrated circuit 111 using a corresponding BMIC X library 150 tailored for each battery monitoring integrated circuit 111 type in the system. The prepared commands are subsequently transmitted through configured communication channels 160 of the battery management system 102 to appropriate endpoints, that may involve direct communication with a specific battery monitoring integrated circuit (e.g., BMIC 111) and/or intermediary modules 162 that transport the requests. For instance, the prepared requests may be sent to a wireless master and routed through a wireless network 164 to wireless nodes, thus eliminating direct communication between the agnostic BMIC controller 114 and the specific battery monitoring integrated circuit 111.

Other software modules 165 may be included to facilitate communications within the battery management system 102. The software modules 165 may include, but are not limited to, send data 166 and receive data 167 type software modules. The software modules 165 may establish communications with the wired and/or wireless network 164 and the console 104.

The BMIC X libraries 150 are predefined communication modules that are operational for interacting with the battery monitoring integrated circuits 111, and implement the data protocols appropriate for communication with the battery monitoring integrated circuits 111. The BMIC X libraries 150 do not store data beyond what is provided via the interfaces. The approach allows the BMIC X libraries 150 to be developed by the suppliers 92 (FIG. 1) according to a standardized API template, facilitating the formation of the requests, and decoding responses. The data buffers 156 reside within the agnostic BMIC controller 114 rather than within the BMIC X libraries 150. Therefore, the data in the data buffers 156 is stored outside the BMIC X libraries 150. The addition, removal, and/or modification of BMIC X libraries 150 may be performed independently from the agnostic BMIC controller 114 to enable system customization without altering the non-modified BMIC X libraries 150 (e.g., the specific BMIX X library). A size of utilized memory in the agnostic BMIC controller 114 may be managed by excluding unused BMIC X libraries 150 from a project.

The mechanism offers several advantages for suppliers of the battery monitoring integrated circuits. The battery monitoring integrated circuits suppliers may provide libraries without developing complex drivers, as the libraries only include the data exchange protocols. The mechanism accelerates project development since the agnostic BMIC controller uses solely configuration adjustments based on system-specific criteria. The mechanism also simplifies a process of changing the battery monitoring integrated circuits within a project with suitable configuration updates.

Embodiments of the disclosure provide a method for integrating analog battery monitoring integrated circuits within a battery management system. The battery management system includes an agnostic BMIC controller (e.g., an agnostic interface mechanism) that decouples communication protocols from the underlying battery monitoring integrated circuits, enabling compatibility with various battery monitoring integrated circuits models. The agnostic interface layer receives data from the battery monitoring integrated circuits in non-standard formats, and converts the data via an abstraction layer into a unified format. The data generally includes battery parameters such as cell voltages, battery module temperatures, battery cell sensing diagnostics, and other relevant metrics.

The unified data format may enable the BMS to calculate a state of charge (SoC), a state of health (SoH), and other battery performance metrics. Mechanisms within the BMS may detect potential issues in the RESS, issue warnings, and/or trigger error signals to the driver of the vehicle 90 in response to identified anomalies. The agnostic interface mechanism generally improves compatibility and flexibility in selection of the battery monitoring integrated circuits by allowing system integrators to incorporate battery monitoring integrated circuits from different manufacturers without modifying the battery controller structure and interface to the cell monitoring units.

An aspect of the disclosure includes a method for abstracting a plurality of software interfaces in a battery management system. The method includes: monitoring a rechargeable energy storage system of a vehicle with a plurality of battery monitoring sensors; receiving data from the plurality of battery monitoring sensors in a plurality of non-standard formats at an agnostic interface layer of an agnostic battery monitoring integrated circuit controller; converting the data received at the agnostic interface layer via an abstraction layer into a unified format; decoupling a plurality of communication protocols of a plurality of battery monitoring interface circuits in the agnostic battery monitoring integrated circuit controller to interact with a specific battery monitoring interface circuit, where the data includes a plurality of cell voltages, a plurality of battery module temperatures, and a plurality of battery cell sensing diagnostics in the rechargeable energy storage system; and transmitting one or more messages to a driver of the vehicle based on the plurality of cell voltages, the plurality of battery module temperatures, and the plurality of battery cell sensing diagnostics.

Another aspect of the disclosure includes selecting a specific library of a plurality of libraries in the agnostic battery monitoring integrated circuit controller tailored to interact with the specific battery monitoring interface circuit, wherein each of the plurality of libraries contain pre-defined communication information to interact with the plurality of battery monitoring interface circuits.

Another aspect of the disclosure includes selecting a different library of the plurality of libraries tailored to interact with a different one of the plurality of battery monitoring interface circuits in response to a replacement of the specific battery monitoring interface circuit with the different battery monitoring interface circuit.

Another aspect of the disclosure includes modifying a particular library of the plurality of libraries without altering the specific library.

Another aspect of the disclosure includes storing the data in a plurality of data buffers in the agnostic battery monitoring integrated circuit controller.

In another aspect of the disclosure, the storing of the data is outside the plurality of libraries.

Another aspect of the disclosure includes receiving a plurality of commands at a standard application programming interface of the agnostic battery monitoring integrated circuit controller; converting the plurality of commands into a single command; and transmitting the single command to the specific battery monitoring interface circuit.

In another aspect of the disclosure, the transmitting of the single command to the specific battery monitoring interface circuit is conveyed through a wireless network.

In another aspect of the disclosure, the unified format supports a calculation of a state of charge and a state of health of the rechargeable energy storage system.

An aspect of the disclosure includes a battery management system having a plurality of battery monitoring sensors and an agnostic battery monitoring integrated circuit controller. The plurality of battery monitoring sensors is operational to monitor a rechargeable energy storage system of a vehicle. The agnostic battery monitoring integrated circuit controller has an agnostic interface layer and an abstraction layer. The agnostic interface layer is operational to receive data from the plurality of battery monitoring sensors in a plurality of non-standard formats. The abstraction layer is operational to convert the data received at the agnostic interface layer into a unified format. The agnostic battery monitoring integrated circuit controller is operational to decouple a plurality of communication protocols of a plurality of battery monitoring interface circuits to interact with a specific battery monitoring interface circuit, where the data includes a plurality of cell voltages, a plurality of battery module temperatures, and a plurality of battery cell sensing diagnostics in the rechargeable energy storage system. The agnostic battery monitoring integrated circuit controller is operational to transmit one or more messages to a driver of the vehicle based on the plurality of cell voltages, the plurality of battery module temperatures, and the plurality of battery cell sensing diagnostics.

In another aspect of the disclosure, the agnostic battery monitoring integrated circuit controller is further configured to select a specific library of a plurality of libraries tailored to interact with the specific battery monitoring interface circuit, wherein each of the plurality of libraries contain pre-defined communication information to interact with the plurality of battery monitoring interface circuits.

In another aspect of the disclosure, the agnostic battery monitoring integrated circuit controller is further configured to select a different library of the plurality of libraries tailored to interact with a different one of the plurality of battery monitoring interface circuits in response to a replacement of the specific battery monitoring interface circuit with the different battery monitoring interface circuit.

In another aspect of the disclosure, a modification of a particular library of the plurality of libraries does not alter the specific library.

Another aspect of the disclosure includes a plurality of data buffers in the agnostic battery monitoring integrated circuit controller operational to store the data.

In another aspect of the disclosure, the data is stored outside the plurality of libraries.

In another aspect of the disclosure, the agnostic battery monitoring integrated circuit controller is further operational to: receive a plurality of commands at a standard application programming interface of the agnostic battery monitoring integrated circuit controller; convert the plurality of commands into a single command; and transmit the single command to the specific battery monitoring interface circuit.

Another aspect of the disclosure includes a wireless network operational to convey the transmission of the single command to the specific battery monitoring interface circuit.

In another aspect of the disclosure, the unified format supports a calculation of a state of charge and a state of health of the rechargeable energy storage system.

Another aspect of the disclosure includes a vehicle that includes a rechargeable energy storage system, a specific battery monitoring interface circuit of, a plurality of battery monitoring sensors, and an agnostic battery monitoring integrated circuit controller. The rechargeable energy storage system has a plurality of battery modules. The specific battery monitoring interface circuit of the plurality of battery monitoring interface circuits is operational to monitor the rechargeable energy storage system. The plurality of battery monitoring sensors is operational to monitor the rechargeable energy storage system. The agnostic battery monitoring integrated circuit controller has an agnostic interface layer and an abstraction layer. The agnostic interface layer is operational to receive data from the plurality of battery monitoring sensors in a plurality of non-standard formats. The abstraction layer is operational to convert the data received at the agnostic interface layer into a unified format. The agnostic battery monitoring integrated circuit controller is operational to decouple a plurality of communication protocols of the plurality of battery monitoring interface circuits to interact with the specific battery monitoring interface circuit, where the data includes a plurality of cell voltages, a plurality of battery module temperatures, and a plurality of battery cell sensing diagnostics in the rechargeable energy storage system. The agnostic battery monitoring integrated circuit controller is operational is operational to transmit one or more messages to the specific battery monitoring interface circuit based on the plurality of cell voltages, the plurality of battery module temperatures, and the plurality of battery cell sensing diagnostics.

In another aspect of the disclosure, the agnostic battery monitoring integrated circuit controller is further operational to: receive a plurality of commands; convert the plurality of commands into a single command; and transmit the single command to the specific battery monitoring interface circuit.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A method for abstracting a plurality of software interfaces in a battery management system comprising:
monitoring a rechargeable energy storage system of a vehicle with a plurality of battery monitoring sensors;
receiving data from the plurality of battery monitoring sensors in a plurality of non-standard formats at an agnostic interface layer of an agnostic battery monitoring integrated circuit controller;
converting the data received at the agnostic interface layer via an abstraction layer into a unified format;
decoupling a plurality of communication protocols of a plurality of battery monitoring interface circuits in the agnostic battery monitoring integrated circuit controller to interact with a specific battery monitoring interface circuit, wherein the data includes a plurality of cell voltages, a plurality of battery module temperatures, and a plurality of battery cell sensing diagnostics in the rechargeable energy storage system; and
transmitting one or more messages to a driver of the vehicle based on the plurality of cell voltages, the plurality of battery module temperatures, and the plurality of battery cell sensing diagnostics.

2. The method according to claim 1, further comprising:
selecting a specific library of a plurality of libraries in the agnostic battery monitoring integrated circuit controller tailored to interact with the specific battery monitoring interface circuit, wherein each of the plurality of libraries contain pre-defined communication information to interact with the plurality of battery monitoring interface circuits.

3. The method according to claim 2, further comprising:
selecting a different library of the plurality of libraries tailored to interact with a different one of the plurality of battery monitoring interface circuits in response to a replacement of the specific battery monitoring interface circuit with the different battery monitoring interface circuit.

4. The method according to claim 3, further comprising:
modifying a particular library of the plurality of libraries without altering the specific library.

5. The method according to claim 2, further comprising:
storing the data in a plurality of data buffers in the agnostic battery monitoring integrated circuit controller.

6. The method according to claim 5, wherein:
the storing of the data is outside the plurality of libraries.

7. The method according to claim 1, further comprising:
receiving a plurality of commands at a standard application programming interface of the agnostic battery monitoring integrated circuit controller;
converting the plurality of commands into a single command; and
transmitting the single command to the specific battery monitoring interface circuit.

8. The method according to claim 7, wherein:
the transmitting of the single command to the specific battery monitoring interface circuit is conveyed through a wireless network.

9. The method according to claim 1, wherein:
the unified format supports a calculation of a state of charge and a state of health of the rechargeable energy storage system.

10. A battery management system comprising:
a plurality of battery monitoring sensors operational to monitor a rechargeable energy storage system of a vehicle; and
an agnostic battery monitoring integrated circuit controller with an agnostic interface layer and an abstraction layer wherein:
the agnostic interface layer is operational to receive data from the plurality of battery monitoring sensors in a plurality of non-standard formats;
the abstraction layer is operational to convert the data received at the agnostic interface layer into a unified format; and
the agnostic battery monitoring integrated circuit controller is operational to decouple a plurality of communication protocols of a plurality of battery monitoring interface circuits to interact with a specific battery monitoring interface circuit, wherein the data includes a plurality of cell voltages, a plurality of battery module temperatures, and a plurality of battery cell sensing diagnostics in the rechargeable energy storage system; and
the agnostic battery monitoring integrated circuit controller is operational to transmit one or more messages to a driver of the vehicle based on the plurality of cell voltages, the plurality of battery module temperatures, and the plurality of battery cell sensing diagnostics.

11. The battery management system according to claim 10, wherein the agnostic battery monitoring integrated circuit controller is further configured to:
select a specific library of a plurality of libraries tailored to interact with the specific battery monitoring interface circuit, wherein each of the plurality of libraries contain pre-defined communication information to interact with the plurality of battery monitoring interface circuits.

12. The battery management system according to claim 11, wherein the agnostic battery monitoring integrated circuit controller is further configured to:
select a different library of the plurality of libraries tailored to interact with a different one of the plurality of battery monitoring interface circuits in response to a replacement of the specific battery monitoring interface circuit with the different battery monitoring interface circuit.

13. The battery management system according to claim 12, wherein:
a modification of a particular library of the plurality of libraries does not alter the specific library.

14. The battery management system according to claim 11, further comprising:
a plurality of data buffers in the agnostic battery monitoring integrated circuit controller operational to store the data.

15. The battery management system according to claim 14, wherein:
the data is stored outside the plurality of libraries.

16. The battery management system according to claim 10, wherein the agnostic battery monitoring integrated circuit controller is further operational to:
receive a plurality of commands at a standard application programming interface of the agnostic battery monitoring integrated circuit controller;
convert the plurality of commands into a single command; and
transmit the single command to the specific battery monitoring interface circuit.

17. The battery management system according to claim 16, further comprising:
a wireless network operational to convey the transmission of the single command to the specific battery monitoring interface circuit.

18. The battery management system according to claim 10, wherein:
the unified format supports a calculation of a state of charge and a state of health of the rechargeable energy storage system.

19. A vehicle comprising:
a rechargeable energy storage system with a plurality of battery modules;
a specific battery monitoring interface circuit of a plurality of battery monitoring interface circuits that is operational to monitor the rechargeable energy storage system;
a plurality of battery monitoring sensors operational to monitor the rechargeable energy storage system; and
an agnostic battery monitoring integrated circuit controller with an agnostic interface layer and an abstraction layer wherein:
the agnostic interface layer is operational to receive data from the plurality of battery monitoring sensors in a plurality of non-standard formats;
the abstraction layer is operational to convert the data received at the agnostic interface layer into a unified format;
the agnostic battery monitoring integrated circuit controller is operational to decouple a plurality of communication protocols of the plurality of battery monitoring interface circuits to interact with the specific battery monitoring interface circuit, wherein the data includes a plurality of cell voltages, a plurality of battery module temperatures, and a plurality of battery cell sensing diagnostics in the rechargeable energy storage system; and
the agnostic battery monitoring integrated circuit controller is operational is operational to transmit one or more messages to the specific battery monitoring interface circuit based on the plurality of cell voltages, the plurality of battery module temperatures, and the plurality of battery cell sensing diagnostics.

20. The vehicle according to claim 19, wherein the agnostic battery monitoring integrated circuit controller is further operational to:
receive a plurality of commands;
convert the plurality of commands into a single command; and
transmit the single command to the specific battery monitoring interface circuit.
